(19) United States
(12) Patent Application Publication
(10) Pub. No.: US 2026/0326377 A1
(43) Pub. Date: Oct. 22, 2026

(54) MULTI-FEEDBACK AUTOMATIC CLEANING PLATFORM MODULE

(71) Applicant: Xinsheng Yan, Jiaxing (CN)

(72) Inventor: Xinsheng Yan, Jiaxing (CN)

(21) Appl. No.: 19/553,257

(22) Filed: Feb. 28, 2026

(51) Int. Cl. B29C 64/35; B33Y 40/00

(52) U.S. Cl. CPC B29C 64/35; B33Y 40/00

(57) ABSTRACT

A multi-feedback automatic cleaning platform module includes a bottom plate with pressure sensors at both ends and the center of one side. Long springs are mounted on the pressure sensors' detection ends, and an aluminum flat plate is placed inside the bottom plate. The flat plate’s lower surface is connected to the springs and a heating sheet, while its upper surface is linked to a magnetic attraction sheet. This module offers simple assembly, wide machine compatibility, high intelligence, and system upgradability. It can be adapted to various three-dimensional (3D) printer systems, including Marlin, Klipper, and RRF, enabling automatic printing for fused deposition modeling (FDM) 3D printers. The system improves printing success rates, increases time efficiency, and reduces manual intervention.

### TECHNICAL FIELD

The present disclosure relates to the technical field of three-dimensional (3D) printing, and specifically relates to a multi-feedback automatic cleaning platform module.

### BACKGROUND

3D printing, i.e. a kind of rapid prototyping technology, manufactures a three-dimensional object based on a digital model file by using a material such as a special wax material or plastic in a layer-by-layer printing manner.

At present, most 3D printers do not have a function of automatic continuous printing.

First, for a flat-plate printing board, a printed object needs to be manually taken after each printing. As a result, the flat-plate printing board has low working efficiency and high dependency on workers.

Second, there is no automatic leveling function or the precision is insufficient. The leveling precision of equipment is related to the success of printing. In early printers, with respect to a hardware function, there is no leveling sensor. Consequently, the equipment needs to be manually debugged, thus wasting time and labor.

Third, an automatic continuous printing function is added to existing 3D printing equipment. A solution for replacing a printing board with a traditional mechanical arm has the shortcomings such as a large volume, high costs, and a large occupied space. Or, a solution for replacing the printing board with an external mechanical module has the problems such as inability to seal a chamber of the equipment and significant transformation.

### SUMMARY

The present disclosure aims to provide a multi-feedback automatic cleaning platform module, to solve the problems mentioned in the above background.

To achieve the above objective, the present disclosure provides the following technical solutions:

A multi-feedback automatic cleaning platform module includes a bottom plate. Pressure sensors are fixedly mounted at two ends of one side of the bottom plate and in a center of the other side. Long springs are fixedly mounted on detection ends of the pressure sensors. An aluminum flat plate is disposed within the bottom plate. A lower end surface of the aluminum flat plate is fixedly connected to upper ends of the long springs. The lower end surface of the aluminum flat plate is fixedly connected to a heating sheet. An upper end of the aluminum flat plate is fixedly connected to a magnetic attraction sheet.

One end of the aluminum flat plate is fixedly connected to a roller shaft bracket. A driving wheel assembly is disposed within the roller shaft bracket. Mounting recesses are formed in two sides of another end of the aluminum flat plate. Driven wheel assemblies are disposed within the mounting recesses. A sheet-like conveyor belt is mounted between the driving wheel assembly and the driven wheel assemblies. A tensioning assembly for tensioning the sheet-like conveyor belt is arranged at a lower end of the bottom plate. A cleaning assembly is arranged at a lower end of the roller shaft bracket.

Preferably, the sheet-like conveyor belt is a flexible base band which is made of polytetrafluoroethylene and is of a closed-loop structure. Uniformly arranged steel sheets are bonded to the base band. The steel sheets are provided with coating layers or patches for enhancing adhesion properties.

Preferably, the driving wheel assembly includes an axle housing and a conductive contact plate mounting base. The axle housing is fixedly connected to one end of the roller shaft bracket, and the conductive contact plate mounting base is fixedly connected to another end of the roller shaft bracket. An inside of the axle housing is fixedly connected to a motor shaft fixing seat. A power roller shaft is arranged between the motor shaft fixing seat and the conductive contact plate mounting base. A speed reduction motor is arranged at one end, close to the motor shaft fixing seat, inside the power roller shaft. The speed reduction motor is fixedly connected to a motor base. An output end of the speed reduction motor is fixedly connected to the motor shaft fixing seat. One end of the power roller shaft close to the conductive contact plate mounting base is fixedly connected to a roller shaft connection shaft. The roller shaft connection shaft is rotatably connected to the conductive contact plate mounting base. One side of the conductive contact plate mounting base close to the power roller shaft is fixedly connected to a conductive contact plate with a sensor. One end, close to the conductive contact plate with the sensor, inside the power roller shaft is fixedly connected to a conductive ejector plate matching the conductive contact plate with the sensor. The speed reduction motor is electrically connected to the conductive ejector plate.

Preferably, the driven wheel assemblies include shaft connectors. The shaft connectors are respectively fixedly connected to positions of the aluminum flat plate located on the two sides of the mounting recesses. A short shaft is fixedly connected between the shaft connectors on the two sides of the mounting recesses. Bearings are arranged at two ends of the short shaft; inner rings of the bearings are fixedly connected to the short shaft. A driven roller shaft is fixedly connected between outer rings of the bearings.

Preferably, the cleaning assembly includes two tensioning seats. The two tensioning seats are respectively fixedly connected to two sides of the roller shaft bracket. Sliding chutes are formed inside the tensioning seats. Insides of the sliding chutes are slidably connected to tensioning sliding blocks. Tensioning springs are arranged between lower ends of the tensioning sliding blocks and a lower end surface of the roller shaft bracket. Clearance holes matching the tensioning sliding blocks are formed in vertical plates on two sides of the roller shaft bracket. A scraper blade is fixedly connected between positions of the two tensioning sliding blocks passing through the clearance holes.

Preferably, the tensioning assembly includes two S-shaped tensioning members. The S-shaped tensioning members are respectively arranged on two sides of the bottom plate. Upper ends of the S-shaped tensioning members are rotatably connected to the bottom plate. A long shaft is rotatably connected between lower ends of the S-shaped tensioning members. Spring seats are arranged on one sides of the S-shaped tensioning members close to the bottom plate. Torsional springs are mounted on the spring seats.

Preferably, one end of the bottom plate away from the power roller shaft is fixedly connected to a tail bracket. A cable management groove is formed in one side of the tail bracket. A center of the tail bracket is fixedly connected to a cleaning elastic sheet. Two sides of the bottom plate are fixedly connected to first decorative plates. Two sides of the roller shaft bracket are fixedly connected to second decorative plates. The first decorative plate on one side of the bottom plate is provided with a main control housing. A main control circuit board is disposed within the main control housing. A functional button and an indicator light are arranged on one side of an upper end of the main control housing. A power switch is arranged on another side of the upper end of the main control housing. A universal serial bus (USB) firmware upgrading interface is arranged at one end of the main control housing. A position sensor is arranged at a lower end of the main control housing.

Preferably, mounting connectors are fixedly connected to positions, close to the power roller shaft, on two sides of the bottom plate and a middle portion of the tail bracket, and the mounting connectors are flat-plate supporting members, S-shaped supporting members, or L-shaped supporting members.

Beneficial effects of the present disclosure are as follows:
1. The present disclosure adopts a sheet-like conveyor belt design, so that magnetic sheet attraction and a small rotation radius of 15 mm are achieved. Compared with the same type of product, a thickness of a product is reduced by 70%, the product is applicable to upgrading of more 3D printers and research and development of new products, printing size occupation is reduced, and a printing volume is increased. Meanwhile, front and rear polygonal roller shafts cooperate with the sheet-like conveyor belt, so that a traction force can be increased, and the roller shafts and a printing plane are decoupled. Thus, the printing plane is smoother, and an adhesion force of printing of a first layer is increased.
2. The bottom plate and a mounting lug of the present disclosure are independently designed. To adapt to different equipment, only the mounting lug needs to be replaced, thereby enhancing adaptability of the module and reducing production costs. In addition, a degree of integration of the module is high. It is convenient for assembling by C-end users, and the costs are low. B-end users can quickly carry out adaptation, thus increasing an equipment commercialization degree.
3. A software system of the present disclosure is compact and closed-loop. A plurality of sensors detect an operating state. An intelligent safety mechanism is perfect and adapts to a two/three/four-Z-axis machine type, thus enhancing intelligence of adaptation to more 3D printers and implementing a hardware basis of automatic demolding of the 3D printers and queue printing.
4. The present disclosure is easy and convenient to mount and debug, has high adaptability to various machine types and high intelligence, and supports system upgrade. It is compatible with mainstream 3D printing systems, achieves fused deposition modeling (FDM) automatic production, enhances a success rate and efficiency of printing, reduces manual labor, and increases a resource utilization rate.

### BRIEF DESCRIPTION OF THE DRAWINGS

FIG. 1 is a schematic diagram of a structure of the present disclosure.

FIG. 2 is a schematic diagram of a structure of a bottom of the present disclosure.

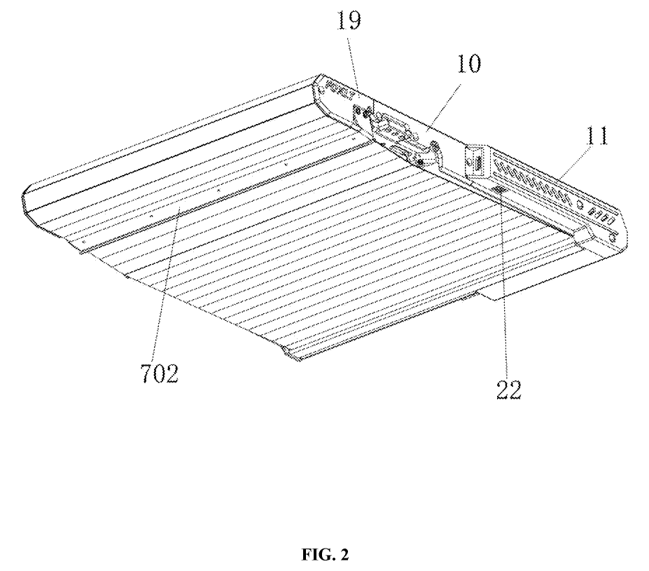

FIG. 3 is a schematic diagram of an exploded structure of a sheet-like conveyor belt in the present disclosure.

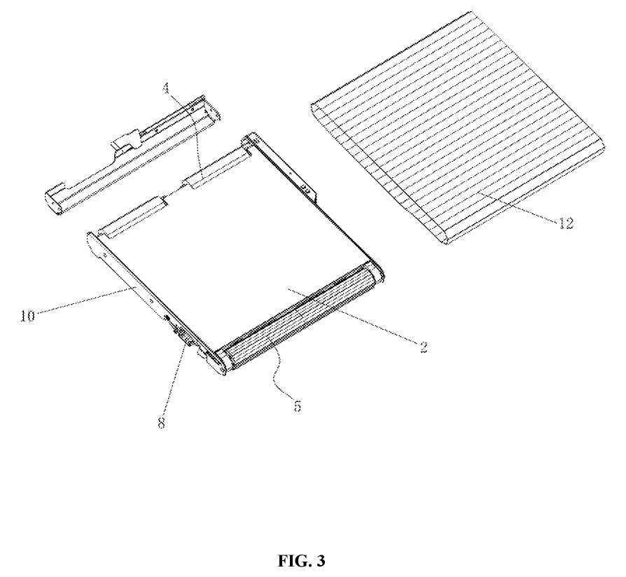

FIG. 4 is a schematic diagram of a partially exploded structure in the present disclosure.

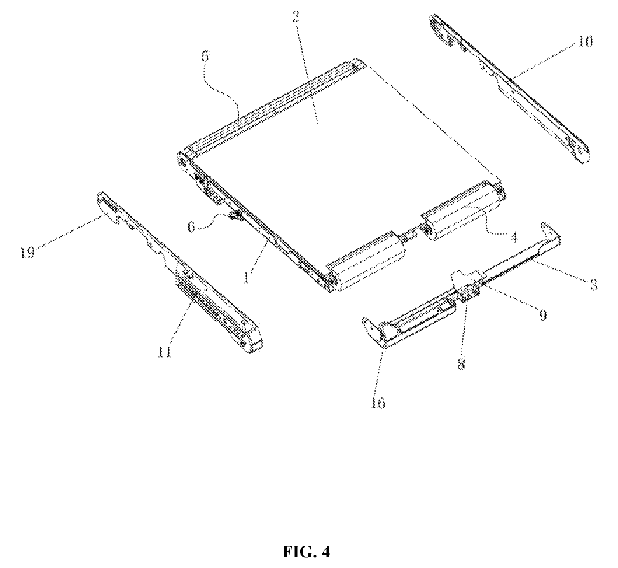

FIG. 5 is a schematic diagram of an exploded structure of a heating platform in the present disclosure.

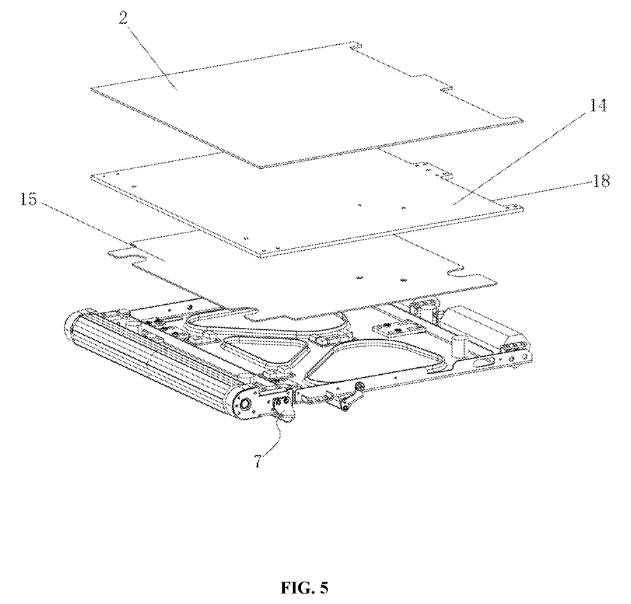

FIG. 6 is a schematic diagram of a structure of a bottom plate in the present disclosure.

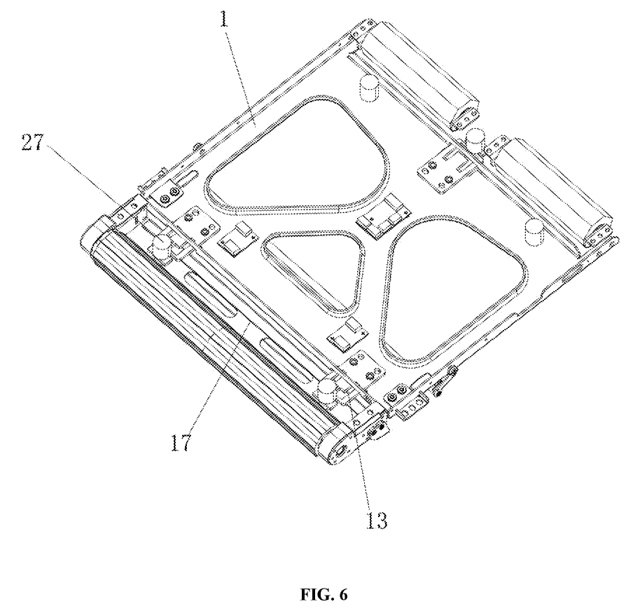

FIG. 7 is a schematic diagram of a structure of a driven wheel assembly in the present disclosure.

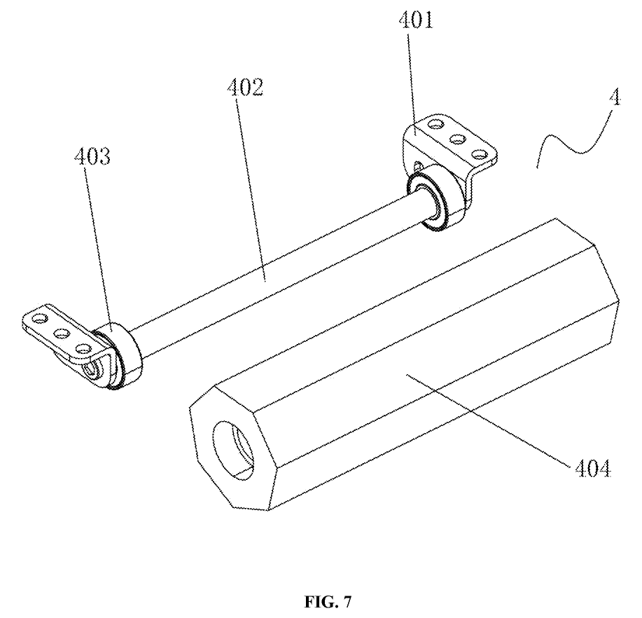

FIG. 8 is a schematic diagram of a structure of a cleaning assembly in the present disclosure.

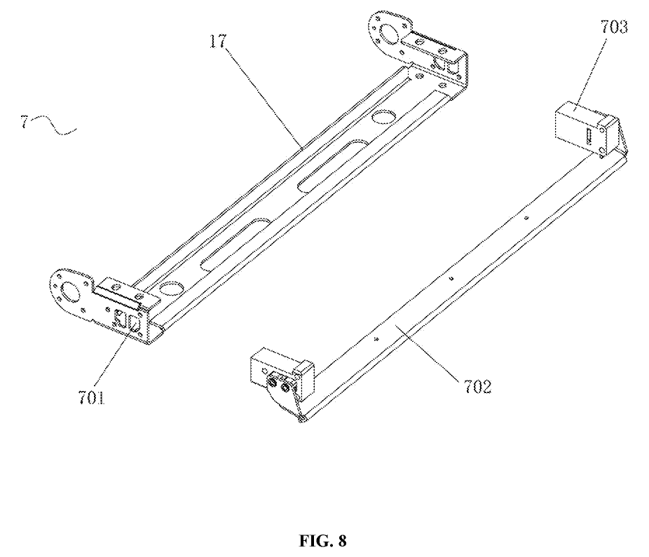

FIG. 9 is a schematic diagram of a structure of a tensioning seat in the present disclosure.

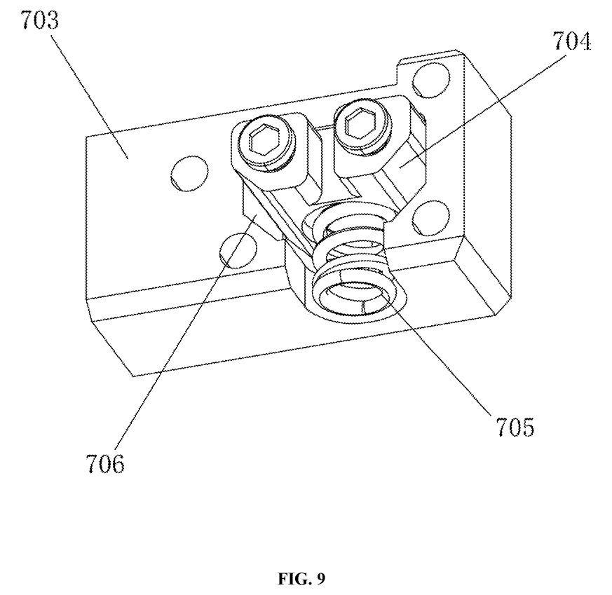

FIG. 10 is a schematic diagram of a structure of a tensioning assembly in the present disclosure.

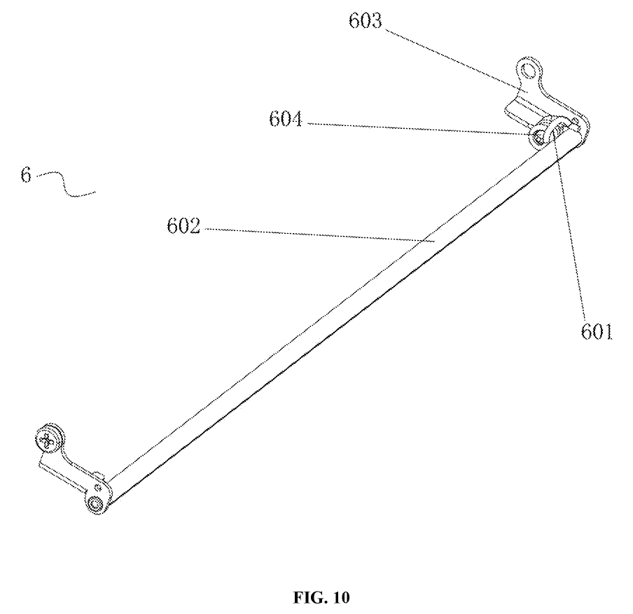

FIG. 11 is a schematic diagram of a structure of a driving wheel assembly in the present disclosure.

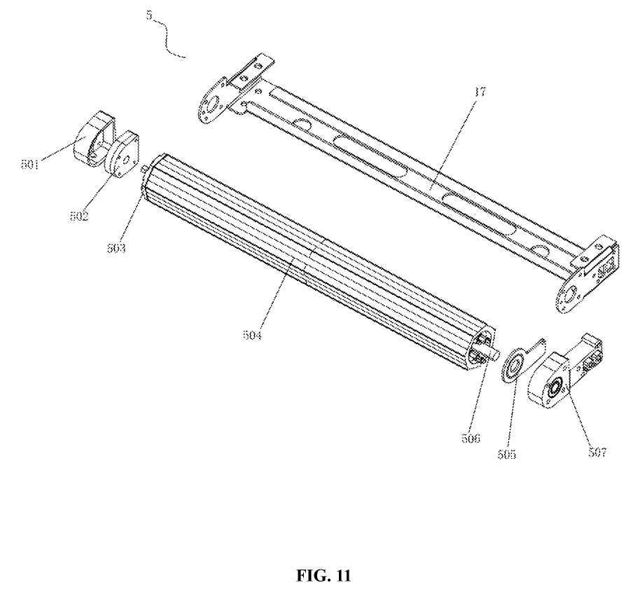

FIG. 12 is a cross-sectional view of a structure of a power roller shaft in the present disclosure.

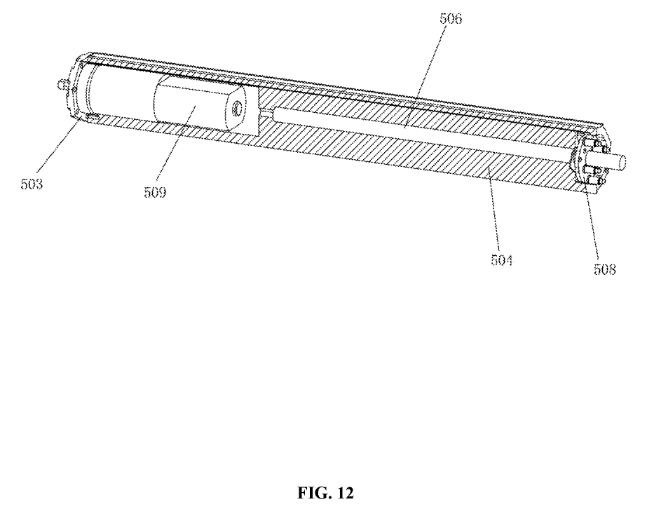

FIG. 13 is a schematic diagram of a structure of a mounting connector in the present disclosure.

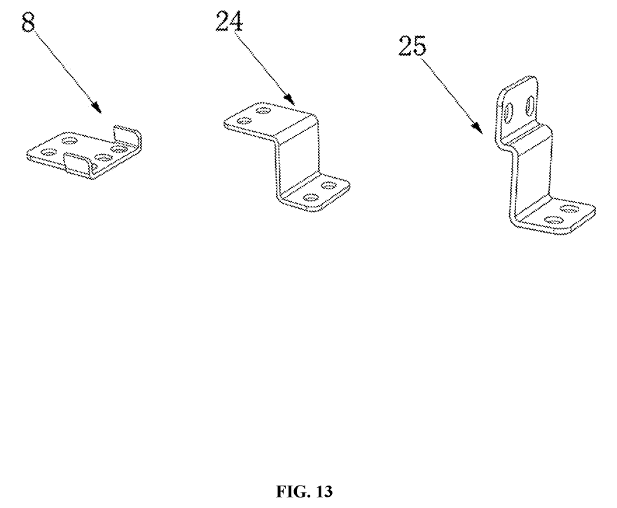

1: bottom plate; 2: magnetic attraction sheet; 3: tail bracket; 4: driven wheel assembly; 5: driving wheel assembly; 6: tensioning assembly; 7: cleaning assembly; 8: flat-plate supporting member; 9: cleaning elastic sheet; 10: first decorative plate; 11: main control housing; 12: sheet-like conveyor belt; 13: pressure sensor; 14: aluminum flat plate; 15: heating sheet; 16: cable arrangement groove; 17: roller shaft bracket; 18: mounting recess; 19: second decorative plate; 20: USB firmware upgrade interface; 21: power switch; 22: position sensor; 23: functional button; 24: S-shaped supporting member; 25: L-shaped supporting member; 26: indicator light; 27: long spring;
401: shaft connector; 402: short shaft; 403: bearing; 404: driven roller shaft;
501: axle housing; 502: motor shaft fixing seat; 503: motor base; 504: power roller shaft; 505: conductive contact plate with sensor; 506: roller shaft connection shaft; 507: conductive contact plate mounting base; 508: conductive ejector plate; 509: speed reduction motor;
601: torsional spring; 602: long shaft; 603: S-shaped tensioning member; 604: spring seat;
701: clearance hole; 702: scraper blade; 703: tensioning seat; 704: tensioning sliding block; 705: tensioning spring; and 706: sliding chute.

### DETAILED DESCRIPTION OF THE EMBODIMENTS

The principle and features of the present disclosure are described below with reference to the accompanying drawings. The illustrated examples are only used to explain the present disclosure and are not intended to limit the scope of the present disclosure.

### Embodiment 1

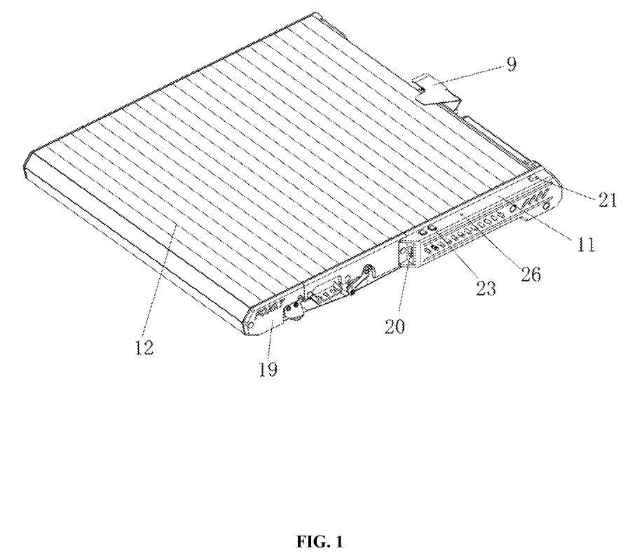

Referring to FIGS. 1- 13, in this embodiment of the present disclosure, a multi-feedback automatic cleaning platform module includes a bottom plate 1. Pressure sensors 13 are fixedly mounted at two ends of one side of the bottom plate 1 and in a center of the other side. Long springs 27 are fixedly mounted on detection ends of the pressure sensors 13. An aluminum flat plate 14 is disposed within the bottom plate 1. A lower end surface of the aluminum flat plate 14 is fixedly connected to upper ends of the long springs 27. The lower end surface of the aluminum flat plate 14 is fixedly connected to a heating sheet 15. An upper end of the aluminum flat plate 14 is fixedly connected to a magnetic attraction sheet 2. The pressure sensors 13 can detect a pressure after a heating platform composed of the aluminum flat plate 14, the magnetic attraction sheet 2, and the heating sheet 15 is in contact with an extruder head of a 3D printer, and pressure data is acquired and is fed back through a lead wire and a connected 3D printer system, so that the printer system can construct a planar height difference model to calibrate Z-axis heights during printing on a plurality of positions of the platform, that is, to level a 3D printer heated bed.

One end of the aluminum flat plate 14 is fixedly connected to a roller shaft bracket 17. A driving wheel assembly 5 is disposed within the roller shaft bracket 17. The driving wheel assembly 5 includes an axle housing 501 and a conductive contact plate mounting base 507. The axle housing 501 is fixedly connected to one end of the roller shaft bracket 17, and the conductive contact plate mounting base 507 is fixedly connected to another end of the roller shaft bracket 17. An inside of the axle housing 501 is fixedly connected to a motor shaft fixing seat 502. A power roller shaft 504 is arranged between the motor shaft fixing seat 502 and the conductive contact plate mounting base 507. A speed reduction motor 509 is arranged at one end, close to the motor shaft fixing seat 502, inside the power roller shaft 504. The speed reduction motor 509 is fixedly connected to a motor base 503. An output end of the speed reduction motor 509 is fixedly connected to the motor shaft fixing seat 502. One end of the power roller shaft 504 close to the conductive contact plate mounting base 507 is fixedly connected to a roller shaft connection shaft 506. The roller shaft connection shaft 506 is rotatably connected to the conductive contact plate mounting base 507. One side of the conductive contact plate mounting base 507 close to the power roller shaft 504 is fixedly connected to a conductive contact plate 505 with a sensor. One end, close to the conductive contact plate 505 with the sensor, inside the power roller shaft 504 is fixedly connected to a conductive ejector plate 508 matching the conductive contact plate 505 with the sensor. The speed reduction motor 509 is electrically connected to the conductive ejector plate 508. The speed reduction motor 509 can drive the power roller shaft 504 to rotate. A conductive slip ring composed of the conductive ejector plate 508 and the conductive contact plate 505 with the sensor supplies power to the speed reduction motor 509 by 360°. The power roller shaft 504 drives the sheet-like conveyor belt 12 to move, so that a printed part printed on the conveyor belt can move. The printed part is subjected to a high tension force when moving to an edge of the power roller shaft 504, thus achieving separation.

Mounting recesses 18 are arranged on two sides of another end of the aluminum flat plate 14, and driven wheel assemblies 4 are disposed within the mounting recesses 18. The driven wheel assemblies 4 include shaft connectors 401. The shaft connectors 401 are respectively fixedly connected to positions of the aluminum flat plate 14 located on the two sides of the mounting recesses 18. A short shaft 402 is fixedly connected between the shaft connectors 401 on the two sides of the mounting recesses 18. Bearings 403 are arranged at two ends of the short shaft 402. Inner rings of the bearings 403 are fixedly connected to the short shaft 402. A driven roller shaft 404 is fixedly connected between outer rings of the bearings 403. Forms of the driven roller shaft 404 and the power roller shaft 504 include but not limited to heptagonal roller shaft shapes, octagonal roller shafts, or the like.

A sheet-like conveyor belt 12 is mounted between the driving wheel assembly 5 and the driven wheel assemblies 4. The sheet-like conveyor belt 12 is a flexible base band which is made of polytetrafluoroethylene and is of a closed-loop structure, so that tension resistance performance of the sheet-like conveyor belt is greatly enhanced, and a problem of cracking of the sheet-like conveyor belt is avoided. Uniformly arranged steel sheets are bonded to the base band. The steel sheets are provided with coating layers or patches. The coating layers can be formed by spraying a power material. The powder material may adopt polyetherimide (PEI). The patches can adopt adhesive polyether amide (PEA) sheets. Adhesion prevention for the steel sheets include but not limited to the above two manners, to solve the problem of adhesion of a first layer in a 3D printing process.

A cleaning assembly 7 is arranged at a lower end of the roller shaft bracket 17. The cleaning assembly 7 is configured to scrape off residue wastes from the sheet-like conveyor belt 12. The cleaning assembly 7 includes two tensioning seats 703. The two tensioning seats 703 are respectively fixedly connected to two sides of the roller shaft bracket 17. Sliding chutes 706 are formed inside the tensioning seats 703. Insides of the sliding chutes 706 are slidably connected to tensioning sliding blocks 704. Tensioning springs 705 are arranged between lower ends of the tensioning sliding blocks 704 and a lower end surface of the roller shaft bracket 17. The tensioning springs 705 provided are configured to apply an upward elastic force to the tensioning sliding blocks 704, so that the scraper blade 702 can be clung to the sheet-like conveyor belt 12 to ensure a cleaning effect. Clearance holes 701 matching the tensioning sliding blocks 704 are formed in vertical plates on two sides of the roller shaft bracket 17. A scraper blade 702 is fixedly connected between positions of the two tensioning sliding blocks 704 passing through the clearance holes 701. During operation of the sheet-like conveyor belt 12, the scraper blade 702 with a bottom abutting against the sheet-like conveyor belt 12 scrapes off tiny wastes retained on a surface of the sheet-like conveyor belt 12, thus implementing deep cleaning on a printing region. Furthermore, in a motion process, the sensor on the conductive contact plate 505 with the sensor detects an angle change of the power roller shaft 504 and precisely controls planeness of an upper surface when the sheet-like conveyor belt 12 stops, to provide higher plane precision for next printing.

A tensioning assembly 6 for tensioning the sheet-like conveyor belt 12 is arranged at a lower end of the bottom plate 1. The tensioning assembly 6 includes two S-shaped tensioning members 603. The S-shaped tensioning members 603 are respectively arranged on two sides of the bottom plate 1. Upper ends of the S-shaped tensioning members 603 are rotatably connected to the bottom plate 1. A long shaft 602 is rotatably connected between lower ends of the S-shaped tensioning members 603. Spring seats 604 are arranged on one sides of the S-shaped tensioning members 603 close to the bottom plate 1. Torsional springs 601 are mounted on the spring seats 604. The torsional springs 601 are configured to drive the long shaft 602 to move downwards to perform internal tensioning on the sheet-like conveyor belt 12. The torsional springs 601 are mounted on the S-shaped tensioning members 603, so that the long shaft 602 achieves a rotatable tensioning function to achieve tensioning by pushing the sheet-like conveyor belt 12 from inside to outside.

One end of the bottom plate 1 away from the power roller shaft 504 is fixedly connected to a tail bracket 3. A cable management groove 16 is formed in one side of the tail bracket 3. A center of the tail bracket 3 is fixedly connected to a cleaning elastic sheet 9. Two sides of the bottom plate 1 are fixedly connected to first decorative plates 10. Two sides of the roller shaft bracket 17 are fixedly connected to second decorative plates 19. The first decorative plate 10 on one side of the bottom plate 1 is provided with a main control housing 11. A main control circuit board is disposed within the main control housing 11. A functional button 23 and an indicator light 26 are arranged on one side of an upper end of the main control housing 11. A power switch 21 is arranged on another side of the upper end of the main control housing 11. A USB firmware upgrading interface 20 is arranged at one end of the main control housing 11. A position sensor 22 is arranged at a lower end of the main control housing 11. The second decorative plates 19 and the first decorative plates 10 that are provided can ensure stability of operation of the sheet-like conveyor belt 12 while achieving a decorative effect, thus avoiding skewing of the sheet-like conveyor belt 12 during operation.

The positions, close to the power roller shaft 504, on the two sides of the bottom plate 1 and the center of the tail bracket 3 are fixedly connected to mounting connectors. The mounting connectors are configured to meet mounting requirements of different 3D printers. The mounting connectors are flat-plate supporting members 8, S-shaped supporting members 24, or L-shaped supporting members 25, but not limited to S-shaped supporting members 24 and L-shaped supporting members 25. When the S-shaped supporting members 24 and the L-shaped supporting members 25 are used, the S-shaped supporting members 24 and the L-shaped supporting members 25 are distributed at four corners of the bottom plate 1.

During automatic cleaning, the USB firmware upgrade interface 20 or a wireless network is first connected to the main control circuit board to complete configuration and pair a corresponding printer. When a built-in program of the main control circuit board detects that the printer has completed a printing operation, the main control circuit board controls a Z axis of the 3D printer to be lowered, to drive the module to be lowered. When the module reaches a specified position and a built-in position sensor 22 of the main control circuit board is triggered, the main control circuit board can control the driving wheel assembly to rotate. The driving wheel assembly drives the sheet-like conveyor belt 12 to move, thus achieving movement of a printed part on the sheet-like conveyor belt 12. When the printed part reaches the edge of the power roller shaft 504, the printed part is subjected to a high tension, thus implementing separation. When the sheet-like conveyor belt 12 continues to operate, the scraper blade 702 with the bottom abuts against the sheet-like conveyor belt 12 scrapes off tiny wastes retained on the surface of the sheet-like conveyor belt 12, thus implementing deep cleaning on a printing region. Furthermore, in a motion process, the sensor on the conductive contact plate 505 with the sensor detects an angle change of the power roller shaft 504 and precisely controls planeness of an upper surface when the sheet-like conveyor belt 12 stops, to provide higher plane precision for next printing.

The working principle of the present disclosure is as follows: During operation, the pressure sensors 13 can detect a pressure after a heating platform composed of the aluminum flat plate 14, the magnetic attraction sheet 2, and the heating sheet 15 is in contact with an extruder head of a 3D printer. The pressure is acquired and is fed back through a lead wire and a connected 3D printer system, so that the printer system can construct a planar height difference model to calibrate Z-axis heights during printing on a plurality of positions of the platform, that is, to level a 3D printer heated bed.

A manual cleaning operation and a manual positioning function are performed. When the printing surface is not completely cleaned by automatic cleaning, or when manual cleaning is required or the conveyor belt needs to be reset because of an equipment motion fault such as jamming, a main control circuit board resetting operation can be triggered through functional button 23. In this case, the power roller shaft 504 can operate for one cycle, and the conductive contact plate 505 with the sensor is used for detection. Finally, calibration on the position of the power roller shaft 504 is completed by comparing detected data with factory data, to complete resetting.

The above describes the preferred embodiments of the present disclosure and is not intended to limit the present disclosure. Any modification, equivalent replacement, and improvement made within the spirit and scope of the present disclosure shall fall within the protection scope of the present disclosure.

What is claimed is:

1. A multi-feedback automatic cleaning platform module, comprising a bottom plate, wherein pressure sensors are fixedly mounted at two ends of one side of the bottom plate and in a center of the other side; long springs are fixedly mounted on detection ends of the pressure sensors; an aluminum flat plate is disposed within the bottom plate; a lower end surface of the aluminum flat plate is fixedly connected to upper ends of the long springs; the lower end surface of the aluminum flat plate is fixedly connected to a heating sheet; an upper end of the aluminum flat plate is fixedly connected to a magnetic attraction sheet;
one end of the aluminum flat plate is fixedly connected to a roller shaft bracket; a driving wheel assembly is disposed within the roller shaft bracket; mounting recesses are formed in two sides of another end of the aluminum flat plate; driven wheel assemblies are disposed within the mounting recesses; a sheet-like conveyor belt is mounted between the driving wheel assembly and the driven wheel assemblies; a tensioning assembly for tensioning the sheet-like conveyor belt is arranged at a lower end of the bottom plate; and a cleaning assembly is arranged at a lower end of the roller shaft bracket.

2. The multi-feedback automatic cleaning platform module according to claim 1, wherein the sheet-like conveyor belt is a flexible base band which is made of polytetrafluoroethylene and is of a closed-loop structure; uniformly arranged steel sheets are bonded to the base band; and the steel sheets are provided with coating layers or patches for enhancing adhesion properties.

3. The multi-feedback automatic cleaning platform module according to claim 1, wherein the driving wheel assembly comprises an axle housing and a conductive contact plate mounting base; the axle housing is fixedly connected to one end of the roller shaft bracket, and the conductive contact plate mounting base is fixedly connected to another end of the roller shaft bracket; an inside of the axle housing is fixedly connected to a motor shaft fixing seat; a power roller shaft is arranged between the motor shaft fixing seat and the conductive contact plate mounting base; a speed reduction motor is arranged at one end, close to the motor shaft fixing seat, inside the power roller shaft; the speed reduction motor is fixedly connected to a motor base; an output end of the speed reduction motor is fixedly connected to the motor shaft fixing seat; one end of the power roller shaft close to the conductive contact plate mounting base is fixedly connected to a roller shaft connection shaft; the roller shaft connection shaft is rotatably connected to the conductive contact plate mounting base; one side of the conductive contact plate mounting base close to the power roller shaft is fixedly connected to a conductive contact plate with a sensor; one end, close to the conductive contact plate with the sensor, inside the power roller shaft is fixedly connected to a conductive ejector plate matching the conductive contact plate with the sensor; and the speed reduction motor is electrically connected to the conductive ejector plate.

4. The multi-feedback automatic cleaning platform module according to claim 1, wherein the driven wheel assemblies comprise shaft connectors; the shaft connectors are respectively fixedly connected to positions of the aluminum flat plate located on the two sides of the mounting recesses; a short shaft is fixedly connected between the shaft connectors on the two sides of the mounting recesses; bearings are arranged at two ends of the short shaft; inner rings of the bearings are fixedly connected to the short shaft; and a driven roller shaft is fixedly connected between outer rings of the bearings.

5. The multi-feedback automatic cleaning platform module according to claim 1, wherein the cleaning assembly comprises two tensioning seats; the two tensioning seats are respectively fixedly connected to two sides of the roller shaft bracket; sliding chutes are formed inside the tensioning seats; insides of the sliding chutes are slidably connected to tensioning sliding blocks; tensioning springs are arranged between lower ends of the tensioning sliding blocks and a lower end surface of the roller shaft bracket; clearance holes matching the tensioning sliding blocks are formed in vertical plates on two sides of the roller shaft bracket; and a scraper blade is fixedly connected between positions of the two tensioning sliding blocks passing through the clearance holes.

6. The multi-feedback automatic cleaning platform module according to claim 1, wherein the tensioning assembly comprises two S-shaped tensioning members; the S-shaped tensioning members are respectively arranged on two sides of the bottom plate; upper ends of the S-shaped tensioning members are rotatably connected to the bottom plate; a long shaft is rotatably connected between lower ends of the S-shaped tensioning members; spring seats are arranged on one sides of the S-shaped tensioning members close to the bottom plate; and torsional springs are mounted on the spring seats.

7. The multi-feedback automatic cleaning platform module according to claim 1, wherein one end of the bottom plate away from the power roller shaft is fixedly connected to a tail bracket; a cable management groove is formed in one side of the tail bracket; a center of the tail bracket is fixedly connected to a cleaning elastic sheet; two sides of the bottom plate are fixedly connected to first decorative plates; two sides of the roller shaft bracket are fixedly connected to second decorative plates; the first decorative plate on one side of the bottom plate is provided with a main control housing; a main control circuit board is disposed within the main control housing; a functional button and an indicator light are arranged on one side of an upper end of the main control housing; a power switch is arranged on another side of the upper end of the main control housing; a universal serial bus (USB) firmware upgrading interface is arranged at one end of the main control housing; and a position sensor is arranged at a lower end of the main control housing.

8. The multi-feedback automatic cleaning platform module according to claim 1, wherein mounting connectors are fixedly connected to positions, close to the power roller shaft, on two sides of the bottom plate and a center of the tail bracket, and the mounting connectors are flat-plate supporting members, S-shaped supporting members, or L-shaped supporting members.
